(19) United States
(12) Patent Application Publication
(10) Pub. No.: US 2020/0196543 A1
(43) Pub. Date: Jun. 25, 2020

(54) AGRICULTURAL IRRIGATION SYSTEM WITH INTEGRAL WHEEL MOTORS

(71) Applicant: LINDSAY CORPORATION, OMAHA, NE (US)

(72) Inventors: Mark William Miller, Elkhorn, NE (US); Richard Edward Provaznik, Omaha, NE (US)

(73) Assignee: LINDSAY CORPORATION, OMAHA, NE (US)

(21) Appl. No.: 16/228,942

(22) Filed: Dec. 21, 2018

(51) Int. Cl. A01G 25/09; B60K 7/00

(52) U.S. Cl. CPC A01G 25/092; A01G 25/16; B60K 7/0007

(57) ABSTRACT

An irrigation system includes a series of spaced mobile towers; support structure connecting the mobile towers to each other; a water-carrying conduit supported by the mobile towers and the support structure; and a plurality of water emitters connected to the conduit for delivering water to a ground surface. At least one of the mobile towers includes an integrated motor and wheel assembly for driving the mobile tower. The integrated motor and wheel assembly includes a wheel; a tire, track or other ground-engaging component mounted on the wheel; and a direct drive motor positioned in or adjacent the wheel for directly driving the wheel. The direct drive motor drives the wheel without a drive shaft and right-angle gear boxes.

### BACKGROUND OF THE INVENTION

### 1. Field of the Invention

The present invention relates to agricultural irrigation systems. More particularly, the invention relates to an irrigation system with mobile towers driven by integral wheel motors.

### 2. Background

Agricultural irrigation systems such as center pivot and lateral move irrigation systems are commonly used to irrigate crops. A center pivot irrigation system typically includes, among other things, a central pivot communicating with a pressurized water supply and a main section that moves about the center pivot to irrigate a circular or semi-circular field. The main section includes a number of mobile support towers connected to the central pivot and to one another by truss-type framework sections. A water distribution conduit is supported by the mobile support towers and framework sections, and a number of sprinkler heads, spray guns, drop nozzles, or other water emitters are spaced along the length of the conduit for irrigating crops below the irrigation system. Lateral irrigation systems are similar except they don't include center pivots and move in a relatively straight line rather than a circle.

The mobile support towers are typically supported on wheels or tracks that are driven by drive trains consisting of electric motors that rotate drive shafts which in turn rotate right angle gear boxes on the wheels or tracks. These drive trains are inefficient and therefore require powerful electric motors that consume a great deal of electricity and require high amperage power cables and associated electrical equipment. Moreover, the rotating drive shafts consist of many discrete rotating parts that are difficult to assemble and maintain and that pose safety hazards.

### SUMMARY

The present invention solves the above-described problems and other related problems by providing an irrigation system with a drive system that is more efficient, easier to install and maintain, and safer to operate.

An irrigation system constructed in accordance with an embodiment of the invention broadly comprises a series of spaced mobile towers; support structure connecting the mobile towers to each other; a water-carrying conduit supported by the mobile towers and the support structure; and a plurality of water emitters connected to the conduit for delivering water to a ground surface. The spaced mobile towers may be connected to a central pivot so as to form a center pivot irrigation system or may form a lateral irrigation system.

At least one of the mobile towers includes an integrated motor and wheel assembly for driving the mobile tower. The integrated motor and wheel assembly includes a wheel; a tire, track or other ground-engaging component mounted on the wheel; and a direct drive motor positioned in or adjacent the wheel for directly driving the wheel. The direct drive motor drives the wheel without a drive shaft and right-angle gear box and therefore eliminates much of the gearing inefficiencies of conventional irrigation system drive trains. This permits use of a smaller motor that consumes less electricity and that can be powered with lower amperage power cables and associated electrical equipment. The integrated motor and wheel assembly is also simpler to install and maintain and eliminates the safety hazards of exposed spinning drive shafts.

One embodiment of the direct drive motor is an inner-rotation motor comprising a motor support fixed to a structural member of the mobile tower and positioned at least partially inside the wheel; a stator attached to the motor support; a rotor rotatably mounted inside the stator and the wheel; and a wheel support shaft supported for rotation with the rotor and coupled with the wheel for rotating the wheel when the rotor rotates.

Another embodiment of the direct drive motor is an outer-rotation motor comprising a motor support fixed to a structural member of the mobile tower and positioned at least partially inside the wheel; a stator attached to the motor support; and a rotor integrated with the wheel and rotatably mounted outside the stator for rotating the wheel when the rotor rotates.

Yet another embodiment of the direct drive motor is an axial-flux motor comprising a motor support fixed to a structural member of the mobile tower and positioned at least partially inside the wheel; a stator attached to the motor support; a rotor attached to the wheel and rotatably mounted beside the stator and within the wheel; and a wheel support shaft supported for rotation with the rotor and coupled with the wheel for rotating the wheel when the rotor rotates.

In some embodiments, the direct drive motors may include permanent magnets and be powered by variable speed drives, which are in turn coupled with a control system, so that the irrigation system may be driven at variable speeds in a continuous move manner rather than in an intermittent manner.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures. For example, the principles of the present invention are not limited to center pivot irrigation systems, but may be implemented in other types of irrigation systems including linear move irrigation systems.

### BRIEF DESCRIPTION OF THE DRAWING FIGURES

Embodiments of the present invention are described in detail below with reference to the attached drawing figures, wherein:

FIG. 1 is a perspective view of an exemplary center pivot irrigation system constructed in accordance with embodiments of the present invention.

FIG. 2 is an enlarged perspective view of one of the integrated motor and wheel assemblies shown removed from its mobile tower.

FIG. 3 is a horizontal sectional view of an embodiment of one of the integrated motor and wheel assemblies.

FIG. 4 is a horizontal sectional view of another embodiment of one of the integrated motor and wheel assemblies.

FIG. 5 is a horizontal sectional view of yet another embodiment of one of the integrated motor and wheel assemblies.

The drawing figures do not limit the present invention to the specific embodiments disclosed and described herein. The drawings are not necessarily to scale, emphasis instead being placed upon clearly illustrating the principles of the invention.

### DETAILED DESCRIPTION

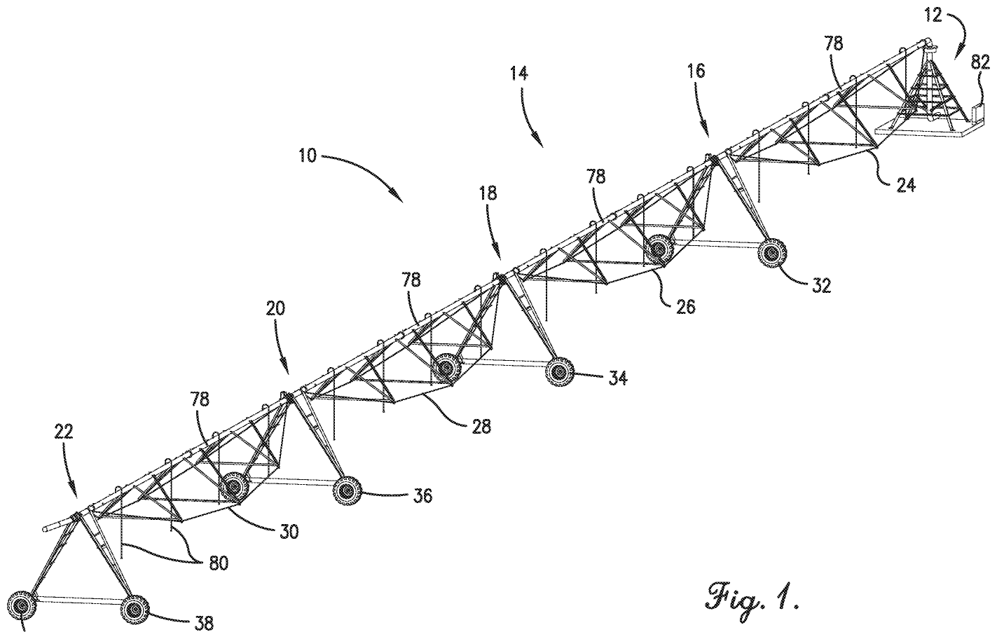

Turning now to the drawing figures, and initially FIG. 1, an irrigation system 10 constructed in accordance with embodiments of the present invention is illustrated. The illustrated irrigation system 10 is a center pivot irrigation system, but it may also be a linear move or lateral type irrigation system or any other type of automated irrigation system. The illustrated irrigation system 10 broadly comprises a fixed center pivot 12 and a main section 14 pivotally connected to the center pivot.

The fixed center pivot 12 may be a tower or any other support structure about which the main section 14 pivots. The center pivot has access to a well, water tank, or other source of water and may also be coupled with a tank or other source of agricultural products to inject fertilizers, pesticides and/or other chemicals into the water for application during irrigation.

The main section 14 pivots or rotates about the center pivot 12 and includes a number of mobile support towers 16-22, the outermost of which is referred to herein as an end tower. The mobile towers are connected to the fixed center pivot 12 and to one another by truss sections 24-30 or other supports to form a number of interconnected spans. The illustrated irrigation system 10 has four mobile support towers, and thus four spans, however, it may comprise any number of towers and spans without departing from the scope of the invention.

In accordance with important aspects of the present invention, at least one of the mobile towers 16-22, and preferably all of the mobile towers, are driven by integrated motor and wheel assemblies 32-38. However, in some embodiments, some of the wheels are “bogey” wheels that are not directly driven by a motor. The integrated motor and wheel assemblies 32-38 are essentially identical, so only one of them will be described in detail below.

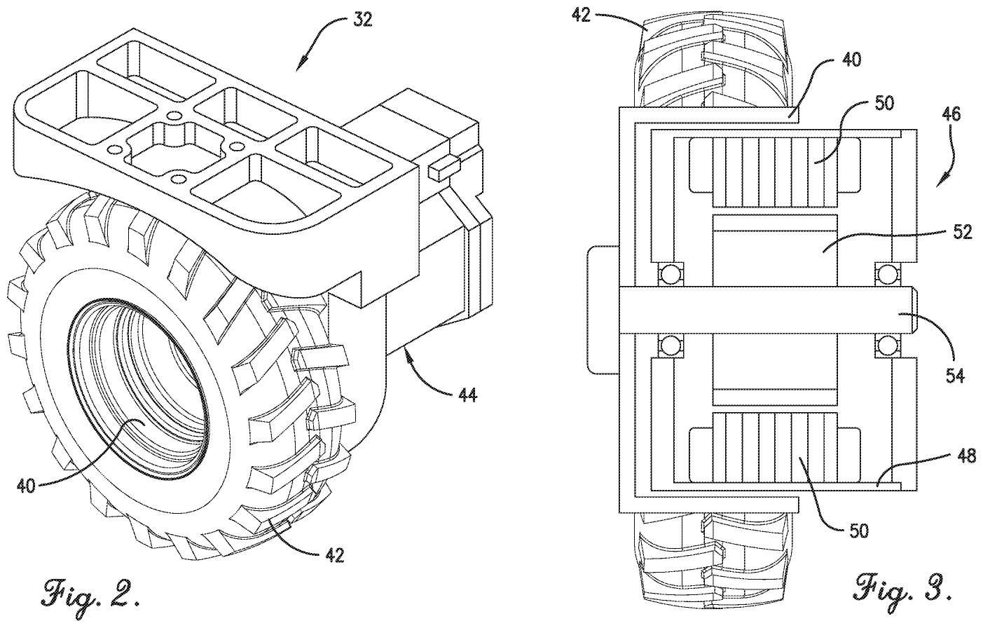

FIG. 2 is an enlarged perspective view of one of the integrated motor and wheel assemblies 32 shown removed from its mobile tower 16. The integrated motor and wheel assembly 32 includes a wheel 40; a tire, track or other ground-engaging component 42 mounted on the wheel 40; and a direct drive motor 44 positioned in or adjacent the wheel 40 for directly driving the wheel. The integrated motor and wheel assembly 32 may also include an internal or external gear reducer and/or other gears for increasing the effective torque of the drive motor.

The wheel 40 may be a conventional wheel or may be integrated in the direct drive motor as described below. Likewise, the tire, track or other ground-engaging component 42 may be a conventional tire or track or may be specially configured to mount on a wheel integrated with the direct drive motor 26.

The direct drive motor 44 is supported partially in or adjacent its respective wheel 40 to directly drive the wheel without a drive shaft or a right-angle gear box. Because of this, much of the gearing inefficiencies of conventional irrigation system drive trains are eliminated so that a smaller more efficient motor may be used. Similarly, because the motor 44 consumes less electricity, lower amperage power cables and associated electrical equipment can be used to deliver electricity to the motor. The direct drive motor 44 may be an electric induction type motor or a permanent magnet type motor. The exact size of the direct drive motor 26 is selected based on the size, weight and operating conditions of its mobile tower. In one embodiment, the motor is rated ______.

Specific embodiments of direct drive motors configured to enhance characteristics of the irrigation system 10 will now be described in more detail. One embodiment of the direct drive motor is an inner-rotation direct drive motor 46 shown in FIG. 3. The inner-rotation direct drive motor 46 comprises a motor support 48, a stator 50, a rotor 52, and a wheel support shaft 54. The motor may also include, or be coupled with, an internal or external gear reducer and/or other gears for increasing the effective torque of the drive motor.

The motor support 48 is fixed to a structural member of its respective mobile tower and is positioned at least partially inside the wheel 40. Thus, the motor support 48 remains stationary as the wheel rotates around it.

The stator 50 comprises conductive windings that are attached to or otherwise supported on the motor support 48. The rotor 52 is rotatably mounted inside the stator 50 and the wheel 40 and comprises one or more permanent magnets or an electrically-conductive set of windings.

The wheel support shaft 54 is attached to or otherwise supported for rotation with the rotor 52 and is also coupled with the wheel 40 for rotating the wheel when the rotor rotates.

The configuration of the inner-rotation direct drive motor 46 is preferred for applications in which easy removal of the wheel 40 and tire 42 is important because the wheel 40 is not part of the motor 46 and can thus be removed separately from the motor.

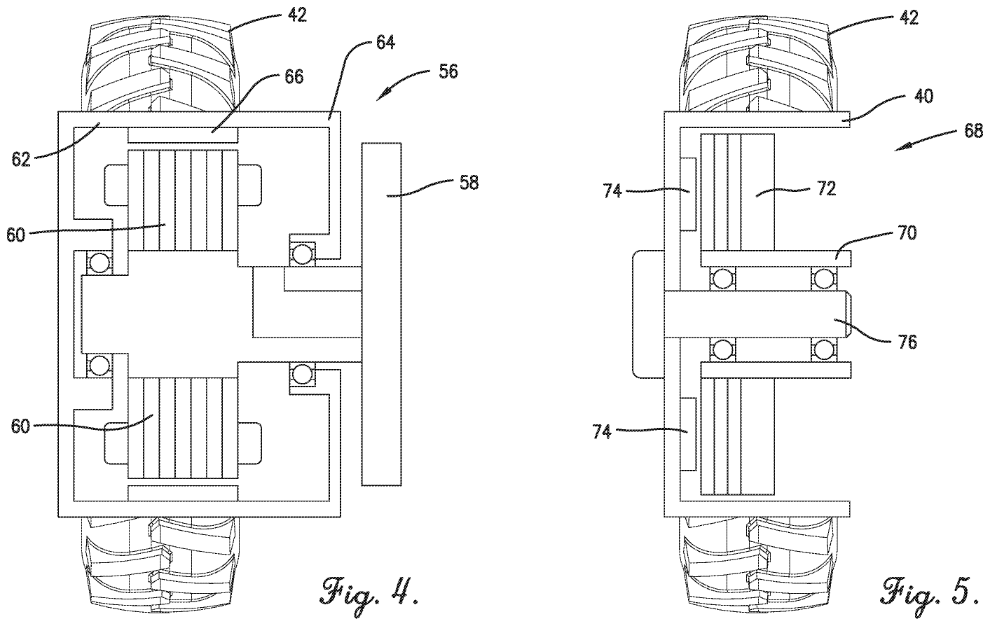

Another embodiment of the direct drive motor is an outer-rotation motor 56 as shown in FIG. 4. The outer-rotation direct drive 56 motor comprises a motor support 58 fixed to a structural member of its respective mobile tower, a stator 60 attached to the motor support 58, and a rotor 62 rotatably mounted outside the stator. The stator 60 may comprise conductive windings that are attached to or otherwise supported on the motor support 58. The rotor 62 may comprise a wheel-like support 64 and one or more permanent magnets 66 or an electrically-conductive set of windings attached to the support 64. In this embodiment, the tire or other ground-engaging component 42 is mounted to the wheel-like support 64 of the rotor so that a separate wheel is not needed. In other words, the rotor serves the functions of a wheel. This embodiment is preferred for applications in which it is desired to fully integrate the rotor and wheel for conserving space.

Yet another embodiment of the direct drive motor is an axial-flux direct drive motor 68 as shown in FIG. 5. The axial-flux direct drive motor 68 comprises a motor support 70 fixed to a structural member of its mobile tower and positioned at least partially inside the wheel 40, a stator 72 attached to the motor support 70, a rotor 74 attached to the wheel 40 and rotatably mounted beside the stator 72 and within the wheel, and a wheel support shaft 76 supported for rotation with the rotor and coupled with the wheel for rotating the wheel when the rotor rotates. The stator 72 may comprise conductive windings that are attached to or otherwise supported on the motor support 70. The rotor 74 may comprise one or more permanent magnets or an electrically-conductive set of windings attached to the wheel 40. This configuration is preferred for applications in which easy removal of the wheel and tire is important because the wheel is not part of the direct drive motor and can thus be removed separately from the direct drive motor. This configuration is also preferred for applications in which space is limited because nearly all of the direct drive motor fits within the inner confines of the wheel.

In some embodiments, the above-described direct drive motors may be powered by variable speed drives, which are in turn are coupled with the control system or another controller so that the irrigation system may be driven at variable speeds in a continuous move manner rather than in an intermittent manner. The motors may also include integral or external relays so they may be turned on, off, and reversed by the control system.

Other mostly conventional aspects of the irrigation system will now be briefly described. Although not required, some or all of the towers 16-22 may be equipped with steerable wheels pivoted about upright axes by suitable steering motors so that the towers can follow a predetermined track. The drive motors may be controlled by a suitable safety system such that they may be slowed or completely shut down in the event of the detection of an adverse circumstance.

The mobile towers and the truss sections carry or otherwise support inter-connected conduit sections 78 or other fluid distribution mechanisms that are connected to a source of fluids from the center pivot. A plurality of sprinkler heads, spray guns, drop nozzles, or other water emitters 80 are spaced along the conduit sections to apply water and/or other fluids to land underneath the irrigation system.

At least one valve is disposed between the conduit sections and the water emitters to control the flow of water through the water emitters. In some embodiments, the irrigation system includes several valves, and each valve controls the flow of water through a single water emitter such that each water emitter can be individually opened, closed, pulsed, etc. to emit any amount of water. In other embodiments, the irrigation system 10 includes several valves that each control the flow of water through a group of water emitters such that the group of water emitters is controlled to emit a specific amount of water. For example, each span of the irrigation system may include four water emitters, and one valve may control the water flow through all four water emitters such that all of the water emitters on a span operate in unison. The valves may be magnetic latching solenoid valves that are normally biased to an off/closed state such that the valves only switch to an on/open state when powered, but they may be any type of valve.

The irrigation system 10 may also include a flow meter that measures water flow rates through the system. Outputs from the flow meter may be provided to the control system. In one embodiment, a single flow meter measures flow rates through the entire irrigation system and provides an indication of this aggregate flow rate to the control system. In other embodiments, multiple flow meters provide flow-rate measurements through different portions of the irrigation system, such as through each span of the irrigation system or even each water emitter.

Embodiments of the irrigation system 10 may also include a pressure regulator for regulating the pressure of water through the irrigation system. Pumps that provide water to the irrigation system may be configured to provide a minimum water pressure, and the pressure regulator then reduces the pump water pressure to a selected maximum pressure level such that the pumps and pressure regulator together provide a relatively constant water pressure through the irrigation system.

The irrigation system 10 may also comprise other components such as an extension arm (also commonly referred to as a “swing arm” or “corner arm”) pivotally connected to the free end of the main section and/or one or more high pressure sprayers or end guns mounted to the end tower or to the end of the extension arm. The end guns are activated at the corners of a field or other designated areas to increase the amount of land that can be irrigated.

The irrigation system 10 may also comprise a control system 82 for controlling operation of the irrigation system. The control system can be located anywhere, such as in a panel beside the center pivot 12 as shown in FIG. 1, and can be implemented with hardware, software, firmware, or a combination thereof. One embodiment of the control system may comprise a processing element, controller, or other computing device; conventional input devices such as knobs, buttons, switches, dials, etc.; inputs for receiving programs and data from external devices; one or more displays; a cellular or other radio transceiver for wirelessly receiving and transmitting data from and to remote devices; a bluetooth transceiver; a wifi transceiver; and/or other electronic components.

The control system controls operational aspects of the irrigation system such as the speed and direction of the mobile towers, and hence the speed of the irrigation system, via control signals provided to the relays connected to the motors 44. Likewise, the control system controls the water flow through the water emitters via control signals provided to the relays connected to the valves. The control system may also control other operational aspects such as a fertilizer application rate, a pesticide application rate, end gun operation, mobile tower direction (forward or reverse), and/or system start-up and/or shut-down procedures.

The control system 82 may control some of the above-described operational aspects of the irrigation system in accordance with an irrigation plan (also sometimes referred to as a “sprinkler chart” or “watering plan”). An irrigation plan specifies how much water to apply to a field, and sometimes to different portions of a field, based on various different criteria such as the types of crops to be irrigated; the soil conditions in various parts of the field; the existence of slopes, valleys, etc. in the field; the existence of roads, buildings, ponds, and boundaries that require no irrigations; crop growth cycles; etc. One or more irrigation plans may be created then stored in memory associated with the control system.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. For example, the principles of the present invention are not limited to the illustrated center pivot irrigation systems but may be implemented in any type of irrigation system including linear move irrigation systems.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Some of the functions described herein may be implemented with one or more computer programs executed by one of the electronic circuits. Each computer program comprises an ordered listing of executable instructions for implementing logical functions and can be embodied in any computer-readable medium for use by or in connection with an instruction execution system, apparatus, or device that can fetch the instructions and execute the instructions. In the context of this application, a “computer-readable medium” can be any means that can contain, store, communicate, propagate or transport the program for use by or in connection with the instruction execution system, apparatus, or device including, but not limited to, the memory of the electronic circuits. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory), an optical fiber, and a portable compact disk read-only memory (CDROM).

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, processing elements such as the electronic circuits may be implemented as special purpose computers or as general purpose computers. For example, the electronic circuits may comprise dedicated circuitry or logic that is permanently configured, such as an application-specific integrated circuit (ASIC), or indefinitely configured, such as an FPGA, to perform certain operations. The electronic circuits may also comprise programmable logic or circuitry (e.g., as encompassed within a general-purpose processor or other programmable processor) that is temporarily configured by software to perform certain operations. It will be appreciated that the decision to implement the electronic circuits as special purpose, in dedicated and permanently configured circuitry, or as general purpose (e.g., configured by software) may be driven by cost and time considerations.

Accordingly, the terms “electronic circuits,” “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the electronic circuits are temporarily configured (e.g., programmed), each of the processing elements need not be configured or instantiated at any one instance in time. For example, where the electronic circuits comprise a general-purpose processor configured using software, the general-purpose processor may be configured as respective different processing elements at different times. Software may accordingly configure the electronic circuits to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of the methods may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Having thus described the preferred embodiment of the invention, what is claimed as new and desired to be protected by Letters Patent includes the following:

1. An irrigation system comprising:
a series of spaced mobile towers;
support structure connecting the mobile towers to each other;
a water-carrying conduit supported by the mobile towers and the support structure; and
a plurality of water emitters connected to the conduit for delivering water to a ground surface;
one of the mobile towers including at least one integrated motor and wheel assembly including—
a wheel;
a ground-engaging component mounted on the wheel; and
a direct drive motor mounted at least partially within the wheel for directly driving the wheel.

2. The irrigation system as set forth in claim 1, wherein the direct drive motor is an inner-rotation motor comprising—
a motor support fixed to a structural member of the mobile tower and positioned at least partially inside the wheel,
a stator attached to the motor support,
a rotor rotatably mounted within the stator and the wheel, and
a wheel support shaft supported for rotation with the rotor and coupled with the wheel for rotating the wheel when the rotor rotates.

3. The irrigation system as set forth in claim 2, wherein the rotor includes permanent magnets.

4. The irrigation system as set forth in claim 2, wherein the rotor includes conductive windings.

5. The irrigation system as set forth in claim 2, wherein the stator includes conductive windings.

6. The irrigation system as set forth in claim 1, further comprising a variable speed drive for selectively energizing the stator so as to rotate the rotor at selected speeds.

7. The irrigation system as set forth in claim 1, wherein the direct drive motor is an outer-rotation motor comprising—
a motor support fixed to a structural member of the mobile tower and positioned at least partially inside the wheel,
a stator attached to the motor support, and
a rotor integrated with the wheel and rotatably mounted outside the stator for rotating the wheel when the rotor rotates.

8. The irrigation system as set forth in claim 1, wherein the direct drive motor is an axial-flux motor comprising—
a motor support fixed to a structural member of the mobile tower and positioned at least partially inside the wheel,
a stator attached to the motor support,
a rotor attached to the wheel and rotatably mounted beside the stator and within the wheel, and
a wheel support shaft supported for rotation with the rotor and coupled with the wheel for rotating the wheel when the rotor rotates.

9. An irrigation system comprising:
a series of spaced mobile towers;
support structure connecting the mobile towers to each other;
a water-carrying conduit supported by the mobile towers and the support structure; and
a plurality of water emitters connected to the conduit for delivering water to a ground surface;
each of the mobile towers including—
at least one integrated motor and wheel assembly including—
a wheel,
a ground-engaging component mounted on the wheel, and
a direct drive motor mounted at lest partially within the wheel for directly driving the wheel; and
a bogey wheel that is not directly driven by the direct drive motor.

10. The irrigation system as set forth in claim 9, wherein the direct drive motor is an inner-rotation motor comprising—
a motor support fixed to a structural member of the mobile tower and positioned at least partially inside the wheel,
a stator attached to the motor support,
a rotor rotatably mounted within the stator and the wheel, and
a wheel support shaft supported for rotation with the rotor and coupled with the wheel for rotating the wheel when the rotor rotates.

11. The irrigation system as set forth in claim 10, wherein the rotor includes permanent magnets.

12. The irrigation system as set forth in claim 10, wherein the rotor includes conductive windings.

13. The irrigation system as set forth in claim 10, wherein the stator includes conductive windings.

14. The irrigation system as set forth in claim 10, the irrigation system further comprising a variable speed drive assembly for energizing the stator.

15. The irrigation system as set forth in claim 9, wherein the direct drive motor is an outer-rotation motor comprising—
a motor support fixed to a structural member of the mobile tower and positioned at least partially inside the wheel,
a stator attached to the motor support, and
a rotor integrated with the wheel and rotatably mounted outside the stator for rotating the wheel when the rotor rotates.

16. The irrigation system as set forth in claim 9, wherein the direct drive motor is an axial-flux motor comprising—
a motor support fixed to a structural member of the mobile tower and positioned at least partially inside the wheel,
a stator attached to the motor support,
a rotor attached to the wheel and rotatably mounted beside the stator and within the wheel, and
a wheel support shaft supported for rotation with the rotor and coupled with the wheel for rotating the wheel when the rotor rotates.
